(19) United States
(12) Patent Application Publication
(10) Pub. No.: US 2019/0106337 A1
(43) Pub. Date: Apr. 11, 2019

(54) Compositions and Methods for Removal of Arsenic and Heavy Metals from Water

(71) Applicant: MESOFILTER INC., San Jose, CA (US)

(72) Inventor: Liangjie DONG, Honolulu, HI (US)

(21) Appl. No.: 16/214,108

(22) Filed: Dec. 9, 2018

Related U.S. Application Data
(63) Continuation of application No. PCT/US17/36922, filed on Jun. 11, 2017.
(60) Provisional application No. 62/349,022, filed on Jun. 12, 2016.

(51) Int. Cl. C02F 1/28; B01J 20/08; B01J 20/28; B01J 20/30

(52) U.S. Cl. CPC C02F 1/281; B01J 20/08; B01J 20/28083; C02F 2101/103; B01J 20/3078; B01J 20/3085; B01J 20/28085

(57) ABSTRACT

A medium for removal of a contaminant in a fluid is provided. The medium includes, when in dry form: about 90% or greater by weight of aluminum oxide; about 0.1% to about 2.0% by weight of zero valent iron (ZVI); and about 1% to about 5% by weight of carbon. Methods for producing the medium are also provided.

### CROSS REFERENCE TO RELATED APPLICATIONS

This application is a continuation of PCT/US17/36922, filed Jun. 11, 2017, which claims priority to U.S. Provisional Application No. 62/349,022, filed Jun. 12, 2016, the disclosure of each of which is incorporated herein by reference in its entirety.

### FIELD OF THE INVENTION

This invention relates to compositions and methods for removing contaminants from a fluid, and more particularly, for removing arsenic and/or heavy metals from water.

### BACKGROUND OF THE INVENTION

Arsenic, a highly poisonous metallic element that is found in rocks, soils and waters, affects more than 100 million people worldwide, according to the World Health Organization (WHO). Naturally occurring Arsenic concentration in groundwater varies from a few ppb to as high as 10 ppm in different areas, but in most cases of arsenic pollution, like Bangladesh, West Bangle, India and Datong Basin, China, the arsenic concentration is on average about 300 ppb in the form of both arsenite and arsenate. In the United States, the Environmental Protection Agency reports that thirteen million people in more than twenty states are affected by arsenic contaminated drinking water. Medical problems linked to arsenic ingestion include skin cancer and bladder cancer, among others.

Since the reverse osmosis technology has poor performance in arsenite removal and generates high concentration of wastewater, much of new technology development efforts have been focused on adsorptive media, especially in the Point of Use water filtration systems. Current industrial technologies for removal of arsenic from water include precipitation, adsorption, reverse osmosis, ion exchange (IX), membrane filtration, greensand filtration. There are also a number of developing technologies for the removal of heavy metals from drinking water, including: iron oxide coated sand, nanofiltration, iron filings, sulfur-modified iron, granular ferric hydroxide, biological settling processes and plant intake methods.

However, these technologies suffer from various deficiencies. For example, filtration methods, including membrane filtration, RO, electrodialysis reversal (EDR) and nanofiltration, can be expensive and difficult to operate. Additionally, disposal of waste is problematic. Membranes tend to clog easily and are thus befouled, and generate concentrated wastewater, which must be treated for further steps. Iron filings, sulfur-modified iron and granular ferric hydroxides all require backwash, and free ferric ions. The biological settling process and plant intake methods are both difficult to operate and are socially unacceptable. Precipitative processes, including coagulation/filtration (C/F), direct filtration, coagulation assisted microfiltration, enhanced coagulations, lime softening, and enhanced lime softening all suffer from problems such as pH adjustment problems and toxic sludge, which is more difficult to treat. Adsorption processes, specifically activated alumina, have low capacity and alumina problems; it also needs a pretreatment for oxidation and pH adjustments. Although carbon-based purification can remove some organic pollutants from drinking water, carbon is ineffective for removing heavy metals and arsenic, particularly As(III) and As(V). Physical purification, such as oxide metals, requires pH adjustment, oxidation process and suffers from clogging.

Additionally, significant issues remain for the safe and effective waste disposal after the water has been purified using the above technologies. There are many other obstacles for solving arsenic pollution such as material limitations, industrial scale-up, waste management, user education, operation and maintenance, cost effectiveness and even social habits.

Zero valent iron (or ZVI, Fe(0), metallic iron) has been found recently to be promising for removal of arsenic as well as other contaminants from groundwater. The mechanism of arsenic removal was suggested to involve adsorption of As(III) and As(V) on iron oxides formed in-situ as a result of the Fe(0) corrosion reaction. However, Fe(0) is prone to oxidize in air and during the oxidation process, the iron leachate to water causes water to become brown or yellow, affecting the water appearance and quality.

U.S. Pat. No. 8,361,920, also to the present inventor, discloses an iron coated pottery granular (ICPG) material that can achieve a high efficiency for the removal of arsenic from water. There, the ICPG media was manufactured by coating pottery granule with iron powder. The adsorption of arsenic occurred mostly through activated adsorptive points which are primarily on the surface of the ICPG media. The adsorptive capacity was relatively low and contact time needed for sufficient contaminant removal was long. It was believed the mechanism of the arsenic removal by ICPG is different from that with pure Fe(0).

There remains a need for improved compositions for arsenic and/or heavy metal removal from water, as well as safe disposal of these toxic substances.

### SUMMARY OF THE INVENTION

The purpose and advantages of the disclosed subject matter will be set forth in and apparent from the description that follows, as well as will be learned by practice of the disclosed subject matter. Additional advantages of the disclosed subject matter will be realized and attained by compositions and methods particularly pointed out in the written description and claims hereof, as well as from the appended drawings.

According to one aspect of the disclosed subject matter, a medium for removal of a contaminant in a fluid is disclosed. The medium comprises, when in dry form: about 90% or greater by weight of aluminum oxide; about 0.1% to about 2.0% by weight of zero valent iron (ZVI); and about 1% to about 5% by weight of carbon. The medium can further comprise SiO₂ of about 0.1% to about 5% by weight of the medium. In some embodiments, the amount of SiO₂ is below 2% by weight of the medium. The fluid can be water.

In some embodiments, the medium has a plurality of pores having diameters between 20 nm to about 70 nm. In certain embodiments, at least 70% of the plurality of pores have a diameter between 40 nm and about 60 nm.

In some embodiments, the medium is in the form of granules. The granules can have an outer diameter in the range of about 0.01 mm to about 3 mm.

The medium can be effective for removal of arsenic, or a heavy metal such as Pb and Cd, from water.

According to another aspect of the disclosed subject matter, a method of producing a medium useful for the removal of a contaminant from water is disclosed. The method includes: mixing a structuring material, a carbon source material, and water, to obtain a raw pottery granule; heating the raw pottery granule in an anoxic atmosphere to form a first pottery granule; contacting the first pottery granule with (a) a solution containing Fe²⁺, and then (b) a reductant capable of reducing Fe²⁺ to ZVI, to form a ZVI-containing porous pottery granule; and heating the ZVI containing porous pottery granule in an anoxic atmosphere to produce the medium.

In some embodiments of the method, the structuring material comprises clay. In some embodiments of the method, the structuring material is obtained by desilicication of diatomaceous earth. In certain embodiments, the method further includes obtaining the structuring material by desilicication of diatomaceous earth.

In certain embodiments, the structuring material comprises more than 90% by weight of aluminum oxide. In these embodiments, the structuring material can further comprise about 0.1 wt % to about 5 wt % of SiO₂.

In some embodiments, the carbon source comprises a carbohydrate, for example, starch or flour.

In some embodiments, the solution containing Fe²⁺ comprises FeSO₄ or FeCl₂.

In some embodiments, the reductant for reducing the Fe²⁺ is a NaBH₄ or KBH₄ solution. In other embodiments, the reductant is H₂ gas.

In a further aspect of the disclosed subject matter, a method of producing a medium useful for the removal of a contaminant from water is disclosed. The method includes: obtaining a first porous pottery granule with pores having walls coated with carbon; contacting the first porous pottery granule with a Fe²⁺ containing solution to result in at least a portion of Fe²⁺ being retained in at least some pores of the pottery granule; contacting the porous pottery granule with a reducing agent capable of reducing Fe²⁺ to ZVI, thereby forming a ZVI-containing porous pottery granule; and heating the ZVI containing porous pottery granule in an anoxic environment to produce the medium. In some embodiments of the method, the reducing agent is NaBH₄ or KBH₄. In some of these embodiments, the Fe²⁺ containing solution comprises FeSO₄ or FeCl₂. In certain embodiments, at least 50% of the pores of the first porous pottery granule have a diameter of about 70 nm to about 100 nm. In certain embodiments, at least 90% of the pores of the first porous pottery granule have a diameter of about 70 nm to about 100 nm.

### BRIEF DESCRIPTION OF THE DRAWINGS

FIG. 1a is an SEM photo of a filtration medium as manufactured according to some embodiments of the present invention, before the filtration medium is used.

FIG. 1b is an SEM photo of a filtration medium according to some embodiments of the present invention after the filtration medium has been used for removal of arsenic from water.

### DETAILED DESCRIPTION

Embodiments of the invention are disclosed herein, in some cases in exemplary form or by reference to one or more FIGURES. However, any such disclosure of a particular embodiment is for illustration purpose only, and is not indicative of the full scope of the invention.

As used herein, the term “arsenic” in connection with arsenic removal refers to the arsenic element as well as its compounds and ions with arsenic in different valence forms, such as in various oxides or salt species, e.g., arsenates (As V) and arsenites ions (As III).

In accordance with one aspect of the disclosed subject matter, a medium (or filtration medium) useful for the removal of a contaminant in a fluid is disclosed. The medium comprises, in dry form: about 90% or greater by weight (or wt %) of aluminum oxide (Al₂O₃); about 0.1% to about 2.0% by weight of ZVI; and about 1% to 5% by weight of carbon. In some embodiments, the medium comprises about 0.2 to about 1.8 wt %, about 0.5 wt % to about 1.5 wt %, about 0.6 wt % to about 1.3 wt %, or about 0.8 wt % to about 1.2 wt % of ZVI. The medium can further comprise SiO₂ in an amount of about 0.1 wt % to about 5 wt %, about 1 wt % to about 3 wt %, about 0.5 wt % to about 2 wt %, about 0.1 wt % to about 0.5 wt %, about 0.5 wt % to about 1 wt %, or about 1 wt % to about 1.5 wt % of that of the medium.

The unused medium is porous and contains a plurality of pores. The pores can have structural walls formed mostly from aluminum oxide, which are coated with carbon and ZVI. In some embodiments, at least 50% of the pores of the medium have a diameter between about 20 nm and about 70 nm. In other embodiments, at least 60%, at least 65%, at least 70%, at least 75%, at least 80%, at least 85%, or at least 90% of the pores of the medium have a diameter between 20 nm to 70 nm. Hereinafter, the porous structure of the medium is also referred to as mesoporous. The pores can be open in structure and form interconnected channels to allow fluid to pass into the medium. In some embodiments, at least 70% of the plurality of pores have a diameter between 40 nm and about 60 nm.

In accordance with another aspect of the disclosed subject matter, a method of producing a filtration medium is disclosed. First, a structuring material is mixed with a carbon source material and water to obtain a raw pottery granule. The raw pottery granule is then heated or fired in an anoxic atmosphere or chamber to form a pottery granule having a plurality of pores (the first heating process). The porous pottery granule is then put into contact first with a solution containing Fe²⁺ and then a reductant capable of reducing Fe²⁺ to ZVI to thereby form a ZVI-containing porous pottery granule. The ZVI containing porous pottery granule is heated in an anoxic atmosphere to produce the filtration medium (the second heating process). Details of the composition for the medium and the method for producing the medium are further described below in conjunction with each other for easy reference and understanding.

In some embodiments, the structuring material can include various clay materials, such as Kaolin, diatomite earth clay, diatomaceous earth, etc. In some embodiments, the structuring material for producing the medium of the present invention comprises aluminum oxide (Al₂O₃) and/or its hydrates. Alternatively, the structuring material can comprise aluminum hydroxide or its hydrates, e.g., gibbsite.

Some clay materials may contain substantial amounts of silica (SiO₂). In some embodiments, desilicication of the structuring material can be first carried out before the first heating process. For example, desilicication for diatomaceous earth can be carried out by contacting diatomaceous earth with Na₂SO₄, NaOH or other suitable chemicals as commonly known in the art, and then removing Si in the form of soluble sodium silicate. It is understood that desilicication may be incomplete, and an insignificant SiO₂ may be still present in the structuring material (e.g., below 2 wt %) after the desilicication.

In some embodiments, the structuring material comprises about 5% to about 95% by weight of aluminum oxide, for example, about 10 wt % to about 90 wt %, about 20 wt % to about 80 wt %, about 30 wt % to about 70 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt %. In some embodiments, the structuring material comprises at least about 70 wt %, at least about 75 wt %, at least about 80 wt %, at least about 85 wt %, or at least about 90 wt % of aluminum oxide. In some embodiments, the structuring material comprises about 0.1 wt % to about 5 wt %, about 0.5 wt % to about 2 wt %, about 0.1 wt % to about 0.5 wt %, about 0.5 wt % to about 1 wt %, about 1 wt % to about 1.5 wt %, or about 1 wt % to about 3 wt % of SiO₂.

In some embodiments, the structuring material may be first subject to grinding to reduce its particle size. In some embodiments, the structuring material can be screened and selected by size fractionation, e.g., by passing a mesh of certain specification, e.g., a 40, 80, 120, 200, 300, 400, 500, 600, 800, 1000, or 1200 standard mesh. In some embodiments, the structuring material and carbon source material are first dry mixed for between about 1 and 20 minutes to combine. Granule makers useful for mixing the clay and carbon source material are commercially available in the ceramic industry. A mixer useful for the present invention may be, for example, a rounded mixer. The structuring material may constitute between about 90 and about 99 wt % of the total dry mix. The carbon source material may constitute between 1 wt % and about 10 wt % of the total dry mix. In some embodiments, the carbon source material constitutes about 2 wt % to about 8 wt % of the total dry mix, e.g., about 5 wt % of the total dry mix. Upon the completion of the first heating process, the amount of carbon produced that is left residing in the porous pottery granule depends on the heating condition, e.g., the heating temperature, temperature ramping speed, the composition of the atmosphere, etc.

For the process of producing the medium, the carbon source material refers to a carbon-containing material that can be at least partially converted to carbon by carbonization. In some embodiments, the carbon source for the present invention can be selected from substances that contain carbohydrates such as lactose, maltose, and sucrose, starch, whey powder, flour, wheat flour, rice flour, cornmeal, oat bran, white sugar, brown sugar, corn starch, potato starch, other starches, wood powders, and coconut shell powders. Such carbon sources are widely commercially available. In some embodiments, the carbon source is starch.

In some embodiments, the mixture of the structuring material and the carbon source material is added water, and then granulated to obtain a wet raw pottery granule. In some embodiments, the amount of water added can be about 5 to about 60 wt % of the dry mix. The water can be substantially removed from the wet mix at suitable drying conditions before the first heating process.

Then the raw pottery granule is heated or fired in a protected or anoxic atmosphere (e.g., an atmosphere maintained by high purity nitrogen gas) to obtain a porous pottery granule. The heating can be conducted in a heat-resistant container, such as an iron bucket, an oven, a ceramic kiln, etc., at a suitable temperature for a sufficient period of time. The heating temperature can be slowly increased from a lower temperature, e.g., about 300 degrees Celsius, at a ramping rate (e.g., about 5° C./min or less) such that water vapor release rate is controlled, to a higher temperature (e.g., about 500 degrees Celsius), and held at that temperature for an extended period of time (e.g., about 3 hours). Such porous pottery granule obtained from the first heating process can have open pores where at least 50% of the pores have a diameter of about 70 nm to about 100 nm. In some embodiments, at least 60%, at least 70%, at least 80%, or at least 90% of the pores have a diameter of about 70 nm to about 100 nm. The carbon produced in the carbonization process can form carbon layers adhering to the walls of the pores which comprise mostly Al₂O₃. At least some of the carbon thus formed is believed to be activated carbon.

The porous pottery granule obtained from the heating is cooled, e.g., to room temperature, and then put into contact with a Fe²⁺ containing solution, for example, immersed in a FeSO₄ solution or FeCl₂ solution for a predetermined period of time, e.g., from about 10 minutes to about 30 minutes, for sufficient permeation of the solution into the pores of the pottery granule. At least a portion of the Fe²⁺ in the solution is retained in the pores of the porous pottery granule. Then, the pottery granule (already treated with Fe²⁺ solution) is contacted with (e.g., immersed in) a reductant capable of reducing Fe²⁺ to ZVI, e.g., a NaBH₄ or KBH₄ solution, for a predetermined duration of time, e.g., from about 20 minutes to about 60 minutes. In such a manner, the reduction of Fe²⁺ to ZVI can occur in-situ inside the pores of the pottery granule. Preferably, the amount of the reductant can be selected that it is sufficient to result in a complete reduction of Fe²⁺ retained in the pores of the pottery granule. The thus obtained granule is herein referred to as ZVI-containing or ZVI-loaded pottery granule.

While the reductant can be a solution containing a reducing agent, in alternative embodiments, the reductant can be H₂ gas. For example, the raw pottery granule containing Fe²⁺ can be directly fired in reduced atmosphere of hydrogen gas and CO, and unused hydrogen gas can be recycled or fired after passing the kiln or oven. In this process, no reductant solution is needed.

The ZVI containing porous pottery granule is then heated in an anoxic/reduced atmosphere to produce the filtration medium. For example, heating the ZVI containing porous pottery granule can be conducted in a nitrogen gas protected atmosphere in a kiln or oven in a temperature range of from about 400° C. to about 600° C. The heating temperature can be slowly increased at a ramping rate of 10° C./min or less, and then held at the final temperature for an extended period of time, e.g., about 3 hours. This heating step immobilizes the Fe(0) with the carbon layers located on the walls of the pores. As a result, the Fe(0) can be evenly distributed with the carbon and does not leach out of the medium when being used for removing contaminants in a fluid. Also, the carbon can protect Fe(0) from being oxidized. After the heating is completed, the kiln is then cooled down to below 70 degrees Celsius, and then the filtration medium is collected and ready for use.

In some embodiments, a filtration medium of the present invention is used to remove a contaminant from a fluid (such as water). In some embodiments, the contaminant is arsenic. In some embodiments, the contaminant is As(III). In other embodiments, the contaminant is As(V). In further embodiments, the contaminant is a heavy metal. In some embodiments, the contaminant is a combination or mixture of heavy metals. As used herein, the term “metal” refers without limitation to an element of Groups 3 through 13, inclusive, of the periodic table. Thus, the term “metal” broadly refers to the all metal elements, including the metalloids. Group 13 elements, and the lanthanide elements. Specific metals suitable for use in the present invention include, for example and without limitation: aluminum (Al), antimony (Sb), arsenic (As), barium (Ba), cadmium (Cd), cobalt (Co), chromium (Cr), copper (Cu), iron (Fe), lead (Pb), mercury (Hg), manganese (Mn), molybdenum (Mo), nickel (Ni), selenium (Se), silicon (Si), silver (Ag), tin (Sn), titanium (Ti), vanadium (V) and zinc (Zn). As used herein, the term “metal” also refers to metal/metallic ions thereof, and salts of the metal thereof. In certain embodiments, the heavy metal is Pb. In other embodiments, the heavy metal is Cd.

In some embodiments, the contaminant is present in the fluid at from about 50 ppb to about 500 ppb. The removal rate of contaminant varies with the contact time.

In some embodiments, a filtration medium of the present invention can have an adsorption capacity for As(III) of, for example, between about 5 mg/g and about 12 mg/g.

In some embodiments, a filter device can be used in conjunction with a filtration medium of the present invention to purify water. The filter device can comprise any type of container which can hold the present filtration media. Preferably, the filter device comprises a cylindrical column. The filter device can be filled with, for example, 10 g to 1000 g of a filtration medium of the present invention.

The filtration media of the present invention can be used in a wide variety of different drinking water filtration systems, such as a small volume water filtration system for a single family home, or a large volume water treatment processes, such as, for example, a drinking water plant. The filtration media of the present invention can also be useful for treating industrial wastewater, or for arsenic and/or heavy metal-containing hazard material storage.

In some embodiments, the filtration media of the present invention can be used as a part of a filtration system, such as fillers for a woven or non-woven filtration material made from natural fibers (e.g., cellulosic fibers), synthetic fibers (e.g., polyethylene, polypropylene, polyurethane, polyester, fiber glass, etc.), or mixtures thereof.

The filtration media of the present invention provide a combination of high throughput filtration, high contaminants removal capacity, and long shelf life. While not wishing to be bound by any particular theory, it is believed that this may be due to synergies of several factors, such as the amount of carbon loading, the sizes of pores of the raw pottery granule, and the in-situ generation of ZVI inside of the pores which results in a large surface area available for active adsorption of arsenic as well as the even distribution of the ZVI with the carbon loaded inside the mesoporous structure of the filtration media which protects the ZVI from oxidation.

The following examples are provided to further certain aspects of the present disclosure by way of illustration and not by way of limitation.

### Example 1: Manufacture of a Filtration Medium

Diatomaceous earth powders from bauxite mining site treated by desilicication were grinded into 1200 standard mesh by air blow selection and separation, and mixed with 5% of starch as carbon source. The mixture powders were granulated in size of 0.5 mm to 1.0 mm raw pottery by adding about 12% to about 15% pure water (on the basis of the weight of the raw pottery). The raw pottery granules thus formed were fired in 500° C. for three hours with a temperature increase rate of 2° C./min to produce a fired medium. The fired medium was submerged in 2% FeSO₄ solution for 15 minutes and naturally leach out the water, and then put into 2% of NaBH₄ solution for 30 minutes for zero valent iron crystallization to occur inside the pores of the medium. The ZVI solution treated medium was fired again in an oven at 480-500° C. for 3 hours with protection of nitrogen during the entire firing process. When the treated medium was cooled down to room temperature, it was stored and ready to use for batch tests and column tests.

### Example 2: Arsenic Adsorption Test—Batch Test

In a standard beaker with 500 ppm arsenic solution arsenite and arsenate sodium, 1 gram of filtration medium prepared by the method described in Example 1 was added with constant mixer for 24 hours.

The filtration medium prepared according to Example 1 was determined to have similar adsorption capacity for arsenite and arsenate at 8.5 mg/g to 9.2 mg/g. At a lower pH (e.g., pH of 4 to 6.5), arsenate adsorption increased. At higher pH (e.g., pH of 8.5 to 10), arsenite adsorption capacity increased.

### Example 3: Arsenic Removal Test

200 g of filtration medium prepared according to Example 1 was packaged in a glass column with 3 cm diameter which was connected with an adjustable speed pump. The contact time (V/flow rate) was set for 15, 30, 60, 90, and 120 seconds. The results showed that the arsenic removal efficiency was affected by its initial influent concentration and other parameters. The column test data showed their relationships in treatment of influent containing arsenic of 50 ppb and 320 ppb. 90 seconds and 75 seconds were required to achieve removal rate of greater than 97%, whereas the ICPG medium made by the previous technology according to U.S. Pat. No. 8,361,920, needed about 15 minutes to attain similar results.

### Example 4: TCLP and SEM Analysis

The toxicity characteristic leaching procedure (TCLP) results of the used filtration medium made according to Example 1 showed that arsenic leach rates were at non-detectable levels based on EPA approved standard method of United States Environmental Protection Agency SW-846 Methods 1311 TCLP.

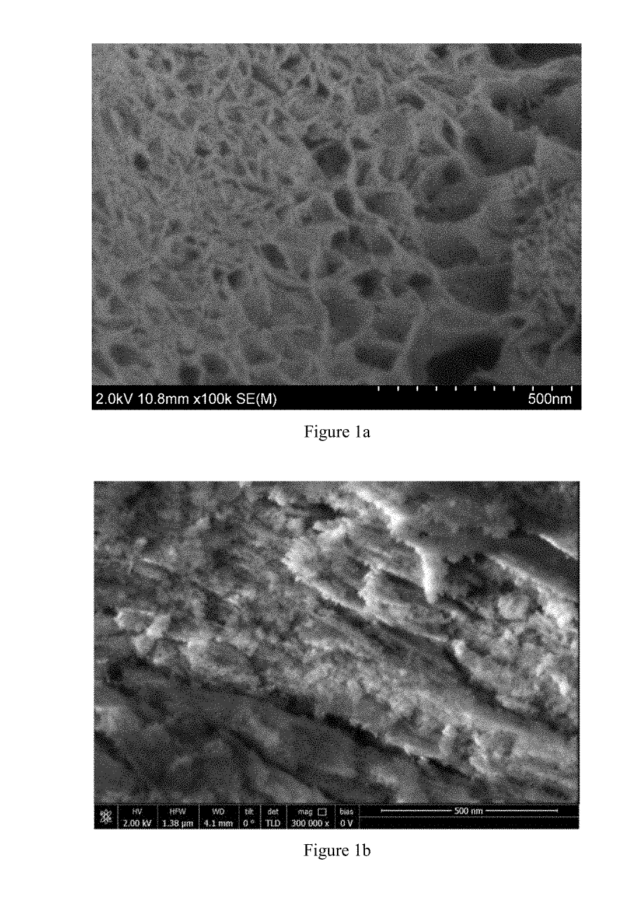

SEM photos show that most of the pores of a filtration medium of the present invention are in the range between about 20 and about 70 nm (FIG. 1a). FIG. 1b shows that the pores of a filtration medium of the present invention are filled with arsenic after adsorption.

### Example 5: Lead Removal Test

A filter is made by packing 90 g of a filtration medium prepared according to Example 1 into a cylinder. The filter was determined to remove 99% Pb in 700 liters of Pb containing water (the Pb concentration is 150 ppb) in a contact time of 45 seconds.

### Example 6: Cellulose Filtration Paper Media

A filtration paper was made by cellulose and the medium made according to Example 1 at a weight ratio of 50%:50% during the paper production process. The dimension of the medium granule is smaller than 200 mesh, and it was sandwiched inside the two layer of cellulose and dried at 120 degrees Celsius. The total thickness of the filtration paper was about 0.7 mm. The filtration paper was cut into a circular shape having a diameter 110 mm, which was placed in a standard funnel. An influent of mixed arsenic (76 ppb), lead (95 ppb) and cadmium (225 ppb) water solution was allowed to form a gravity flow across the filtration paper at a flow rate of 30 ml/min. The removal rates for the above three contaminant species were 49%, 57% and 67%, respectively. In comparison, a regular filter paper such as a Whatman filter paper only achieves less than 4% removal rates.

It will be apparent to one skilled in the art that varying substitutions and modifications can be made to the invention disclosed herein without departing from the scope and spirit of the invention.

What is claimed is:

1. A medium having a plurality of pores useful for the removal of a contaminant in a fluid, comprising, when in dry form:
about 90% or greater by weight of aluminum oxide (Al₂O₃);
about 0.1% to about 2.0% by weight of zero valent iron (ZVI); and
about 1% to about 5% by weight of carbon.

2. The medium of claim 1, further comprising 5102 in the amount of about 0.1% to about 5% by weight of the medium.

3. The medium of claim 2, wherein the amount of SiO₂ is below 2% by weight of the medium.

4. The medium of claim 1, wherein the plurality of pores comprises pores having diameters between 20 nm to about 70 nm.

5. The medium of claim 1, wherein at least 70% of the plurality of pores have a diameter between 40 nm and about 60 nm.

6. The medium of claim 1, wherein the medium is in the form of granules.

7. The medium of claim 6, wherein the granules have an outer diameter in the range of about 0.01 mm and about 3 mm.

8. The medium of claim 1, wherein the medium is effective for removal of arsenic from water.

9. The medium of claim 1, wherein the medium is effective for removal of a heavy metal from water.

10. The medium of claim 1, wherein the medium is effective for removal of Pb from water.

11. A method of producing a medium useful for the removal of a contaminant from water, comprising:
mixing a structuring material, a carbon source material, and water, to obtain a raw pottery granule;
heating the raw pottery granule in an anoxic atmosphere to form a first pottery granule;
contacting the first pottery granule with: (a) a solution containing Fe²⁺, and then (b) a reductant capable of reducing Fe²⁺ to ZVI, to form a ZVI-containing porous pottery granule; and
heating the ZVI containing porous pottery granule in an anoxic atmosphere to produce the medium.

12. The method of claim 11, wherein the structuring material comprises clay.

13. The method of claim 11, wherein the structuring material is obtained by desilicication of diatomaceous earth.

14. The method of claim 11, wherein the structuring material comprises more than 90% by weight of aluminum oxide.

15. The method of claim 14, wherein the structuring material further comprises about 0.1 wt % to about 5 wt % of SiO₂.

16. The method of claim 11, wherein the carbon source material comprises a carbohydrate.

17. The method of claim 16, wherein the carbohydrate is starch.

18. The method of claim 11, wherein the solution containing Fe²⁺ comprises FeSO₄.

19. The method of claim 11, wherein the reductant is a NaBH₄ solution.

20. The method of claim 11, wherein the reductant is a KBH₄ solution.

21. The method of claim 11, wherein the reductant is H₂ gas.

22. A method of producing a medium useful for the removal of a contaminant from water, comprising:
obtaining a first porous pottery granule with pores having walls coated with carbon;
contacting the first porous pottery granule with a Fe²⁺ containing solution to result in at least a portion of Fe²⁺ being retained in at least some pores of the first pottery granule;
contacting the first porous pottery granule with a reducing agent capable of reducing Fe²⁺ to ZVI, thereby forming a ZVI-containing porous pottery granule; and
heating the ZVI containing porous pottery granule in an anoxic atmosphere to produce the medium.

23. The method of claim 22, wherein the reducing agent is NaBH₄ or KBH₄.

24. The method of claim 22, wherein the Fe²⁺ containing solution comprises FeSO₄.

25. The method of claim 22, wherein at least 50% of the pores of the first porous pottery granule have a diameter of about 70 nm to about 100 nm.

26. The method of claim 22, wherein at least 90% of the pores of the first porous pottery granule have a diameter of about 70 nm to about 100 nm.
